(19) United States
(12) Patent Application Publication
(10) Pub. No.: US 2025/0057146 A1
(43) Pub. Date: Feb. 20, 2025

(54) SNAKE LURE, CONTAINMENT, AND RETRIEVAL METHODS AND APPARATUS

(71) Applicant: David S. Easton, San Diego, CA (US)

(72) Inventor: David S. Easton, San Diego, CA (US)

(21) Appl. No.: 18/781,865

(22) Filed: Jul. 23, 2024

Related U.S. Application Data
(60) Provisional application No. 63/532,980, filed on Aug. 16, 2023.

(51) Int. Cl. A01M 23/20; A01M 31/00; G06V 10/75; G06V 40/10

(52) U.S. Cl. CPC A01M 23/20; A01M 31/002; G06V 10/751; G06V 40/10

(57) ABSTRACT

Ways to lure, contain, and retrieve animals such as snakes are described. A snake lure that may be able to house or enclose an attracted animal is described. Animals such as Burmese pythons are a serious problem for residents of locations such as Florida. Existing traps that use snake pheromones as an attractant have had little success. These snakes typically hunt at night using infrared to locate heat sources such as prey. In addition, snakes may den in warm places. Currently, snakes may be found in locations such as on road surfaces that hold warmth from the sun until after dark. Thus, the snake lure of some embodiments may simulate a den or other warm area as an attractant.

### CROSS-REFERENCE TO RELATED APPLICATIONS

This application claims priority to U.S. Provisional Patent Application Ser.

No. 63/532,980, filed on Aug. 16, 2023.

### BACKGROUND OF THE INVENTION

Invasive animals such as Burmese pythons are a serious problem for residents of locations such as Florida.

Therefore, there exists a need for ways to attract, contain, and retrieve such animals.

### BRIEF DESCRIPTION OF DRAWINGS

The novel features of the disclosure are set forth in the appended claims. However, for purposes of explanation, several embodiments are illustrated in the following drawings.

FIG. 1 illustrates an example overview of one or more embodiments described herein, in which a snake lure attracts a target animal;

FIG. 2 illustrates a top, front, right perspective view of an exemplary snake lure of one or more embodiments described herein;

FIG. 3 illustrates a top, front, right perspective view of the exemplary snake lure of one or more embodiments described herein, where the housing is transparent such that interior features are visible;

FIG. 4 illustrates a schematic block diagram of an environment of one or more embodiments described herein;

FIG. 5 illustrates a flow chart of an exemplary process that lures an animal;

FIG. 6 illustrates a flow chart of an exemplary process that manages an animal; and

FIG. 7 illustrates a schematic block diagram of one or more exemplary devices used to implement various embodiments.

### DETAILED DESCRIPTION OF THE INVENTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide ways to lure, contain, and retrieve animals such as snakes. A snake lure of some embodiments may be able to house or enclose an attracted animal.

Animals such as Burmese pythons are a serious problem for residents of locations such as Florida. Existing traps that use snake pheromones as an attractant have had little success. These snakes typically hunt at night using infrared to locate heat sources such as prey. In addition, snakes may den in warm places. Currently, snakes may be found in locations such as on road surfaces that hold warmth from the sun until after dark. Thus, the snake lure of some embodiments may simulate a den or other warm area as an attractant.

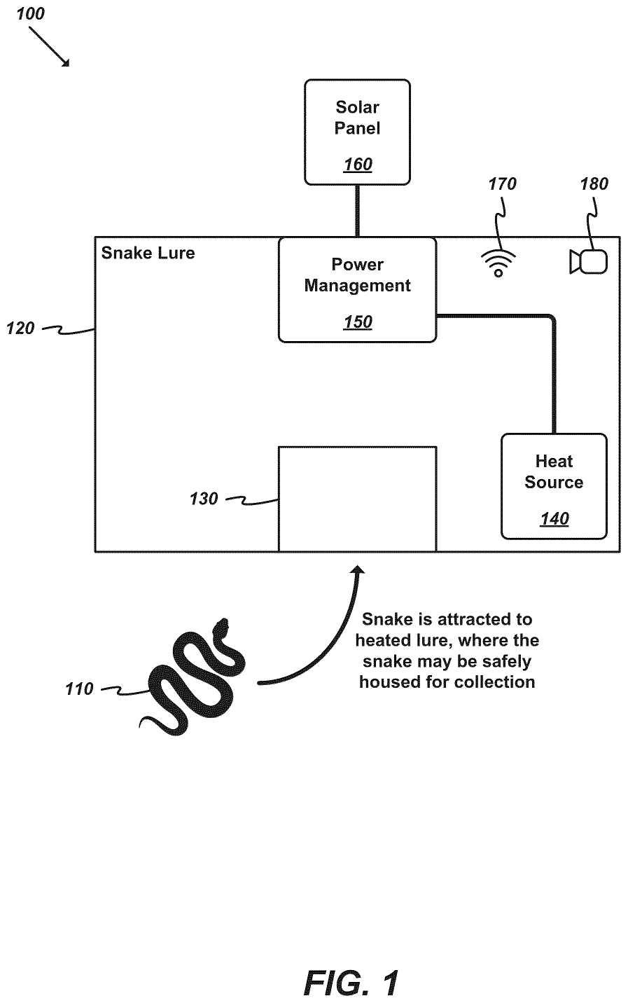

FIG. 1 illustrates an example overview of one or more embodiments described herein, in which a snake lure 100 attracts a target animal 110. As shown, snake lure 100 may include an enclosure or housing 120, an entry port 130, a heat source 140, a power management module 150, a set of solar panels 160, a communication module 170, sensors 180, and/or other appropriate components (e.g., user interface (UI) features, a collection port, one or more controllers, actuators, etc.).

Snake lure 100 may include various components, such as electronic components, mechanical components, etc. Snake lure 100 may be self-contained, such that, for example, power is collected and stored at the snake lure 100.

Enclosure 120 may be sized for personal use (e.g., for a homeowner to place in a back yard), community environments (e.g., a government entity may manage a larger snake lure 100 that may be sized for collection of multiple snakes at a time), and/or other relevant applications. In this example, enclosure 120 has a cuboid shape, but different embodiments may have different shapes, as appropriate for a given environment (e.g., dome-shaped, a cuboid with a sloped roof, etc.). As one example, enclosure 120 may be about five feet wide, five feet deep, and three feet tall. Enclosure 120 may include rigid or semi-rigid materials such as plastic, metal, wood, etc. Enclosure 120 may include various handles, recesses, etc. (not shown) that may allow the snake lure 100 to be easily transported.

In some embodiments, enclosure 120 may include graphics, text, or other UI features along portions of an exterior surface of the enclosure 120. Such UI features may include, for example, instructions or contact information for animal collection resources that are able to safely remove the trapped animal.

Entry port 130 may be an opening, doorway, or other similar port that may allow an animal such as a snake to enter or leave the enclosure 120. In some embodiments, entry port 130 may be associated with a door, gate, latch, or similar retaining element (not shown) that may prevent an animal from leaving the enclosure 120. Such a door, gate, or latch may be implemented in various appropriate ways. For example, a door or gate may slide along tracks at the vertical sides of entry port 130. As another example, a door may be attached to a side of the entry port 130 via one or more hinges, and a spring or similar element may be used to close (or open) the door.

Entry port 130 may allow multiple animals to enter the enclosure 120 (e.g., via a one-way hinged door), while retaining those already inside. Such a door or latch may be associated with automated control features (such as actuators), and/or manual control features, that may allow the door or latch to be closed or opened (or locked or unlocked, latched or unlatched, etc.) based on various relevant factors (e.g., whether an animal is detected within the enclosure, based on user inputs, etc.). The door or gate may be able to be controlled via an external resource such as a smartphone or other user device. Entry port 130 may be sized appropriately for a target animal 110 (e.g., a Burmese python). In this example, the entry port 130 may be located on a front face of enclosure 120.

Heat source 140 may be an electrically powered heat source, such as a heat lamp, silicone heat pad, heat rock, etc. Because animals such as snakes may be able to sense infrared radiation, the heat source 140 may only need to achieve a temperature one or two degrees above ambient temperatures to attract such animals. In some embodiments, snake lure 100 may include other attractants than a heat source 140. For instance, speakers may be used to generate sounds that attract a target animal. As another example, display elements may be used to generate visual stimuli that attract a target animal.

Power management module 150 may be able to collect (e.g., via solar panel 160), store, and/or distribute power among the components of the snake lure 100. Power management module 150 may include, utilize, and/or otherwise be associated with, components such as batteries or other storage elements, transformers, and/or other appropriate components and/or circuitry. Power management module 150 may include one or more controllers, processors, or similar components that are able execute instructions, manipulate data, and/or at least partially direct operations of other components.

Solar panel 160 may collect solar energy and provide the collected energy to the power management module 150. Different embodiments may include various different energy collection elements or power sources, such as a wired power connection, a hydroelectric power source, a thermoelectric generator, etc., depending on the operating environment and/or other relevant factors. A power source such as a solar panel 160 may allow the snake lure 100 to operate as a standalone device where alternative power sources are not available.

Communication module 170 may allow the snake lure 100 to communicate with various devices (e.g., smartphones, tablets, personal computers, wearable devices, servers, other snake lures 100, etc.) across various communication channels. For instance, the communication module 170 may be able to communicate across local wired and/or wireless channels (e.g., Bluetooth). As another example, communication module 170 may be able to communicate across various networks (e.g., Wi-Fi, Ethernet, cellular, the Internet, etc.).

Sensors 180 may include various types of sensors, such as cameras (e.g., visible light, infrared, etc.), microphones, heat sensors, scales, environmental sensors (e.g., temperature, humidity, atmospheric pressure, etc.), and/or other appropriate sensors (e.g., magnetic sensors able to determine whether the entry port 130 is open or closed). Sensors 180 may be coupled to (and/or otherwise associated with) interior and/or exterior surfaces of the enclosure 120.

Snake or other target animal 110 may be a reptile or other animal that may be attracted to a heat source, such as heat source 140. Although various examples herein may refer to snakes as the target animal 110, one of ordinary skill in the art will recognize that similar devices, systems, components, and/or algorithms may be utilized with other types of animals (e.g., other reptiles, mammals, fish, birds, etc.), as appropriate.

Snake lure 100 may include various other components, as appropriate. For example, snake lure 100 may include or utilize various UI components (e.g., display screens, keypads, pushbuttons, etc.) that may allow a user to interact with the snake lure 100.

In some embodiments, snake lure 100 may be implemented via a “string” and/or other collection of elements. For instance, a system of some embodiments may include a set of snake lures 100 distributed about an area and communicatively coupled to a management resource such as a server. In this way, animal management personnel (for example) may be directed to snake lures 100 from the distributed set that have identified an animal within the enclosure 120, such that time is not wasted manually evaluating empty snake lures 100.

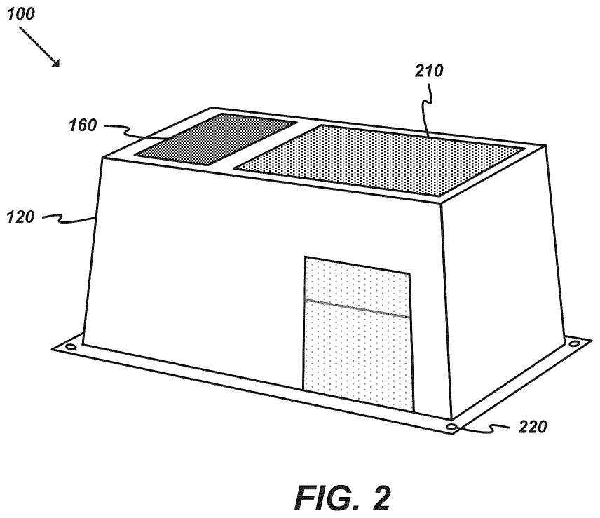

FIG. 2 illustrates a top, front, right perspective view of an exemplary snake lure 100 of one or more embodiments described herein. As shown, the snake lure 100 may include a lid 210 and a set of attachment elements 220.

In this example, housing 120 may have a trapezoidal prism shape. Housing 120 may include various channels, gutters, and/or other appropriate elements (not shown) that may allow water to run off the housing 120.

Lid 210 may include, be associated with, and/or otherwise utilize features such as hinges, locks or latches, handles, etc. that may allow a user (e.g., an animal control worker) to open the lid 210 and access the contents of the housing 120. Lid 120 may be transparent such that the user may be able to evaluate the contents of the housing 120 while the lid 120 is closed.

Each attachment element 220 may be, include, and/or utilize elements such as through-holes, cleats, eyelets, etc. that may allow the snake lure 100 to be secured at a particular location. In this example, each attachment element 220 is a through-hole that may be able to accept a portion of an element such as a tent spike that may retain the snake lure 100 at a particular location when a spike is driven into the ground though the attachment element 220. As another example, attachment elements may include weights or other elements that may help retain the snake lure 100 at a desired location.

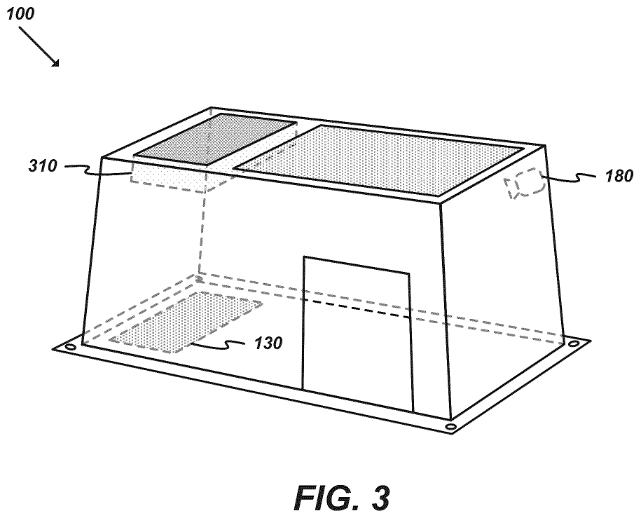

FIG. 3 illustrates a top, front, right perspective view of the exemplary snake lure 100 of one or more embodiments described herein, where the housing 120 is transparent such that interior features are visible.

Electronics housing 310 is a cuboid-shaped element in this example. The electronic housing 310 may house elements such as power management module 150, communication module 170, sensor(s) 180, and/or other appropriate elements (e.g., a control module associated with heat source 140, inverters and/or other power management components associated with solar panel 160, batteries, sensor control modules, etc.). One of ordinary skill in the art will recognize that the electronics housing 310 may be various different sizes or shapes and/or may be located at various different positions associated with the housing 120. In addition, various components associated with the electronics housing 310 (e.g., wiring) may be distributed along and/or throughout different sections of the housing 120.

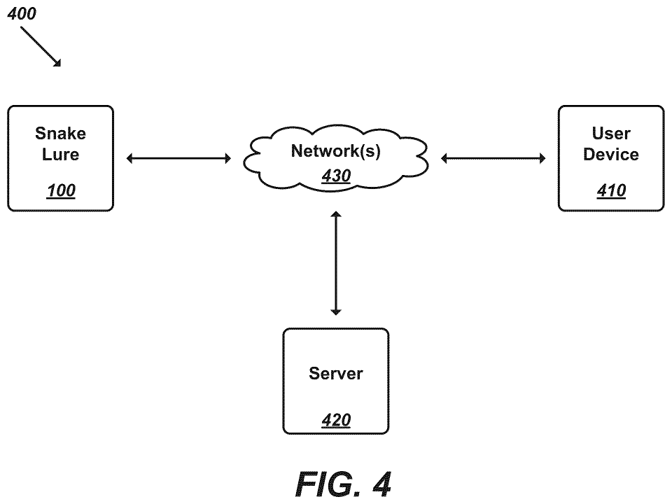

FIG. 4 illustrates a schematic block diagram of an environment 400 of one or more embodiments described herein. As shown, environment 400 may include any number of snake lures 100, user devices 410, server(s) 420, network(s) 430, and/or other appropriate elements, components, devices, and/or systems.

Snake lure 100 may be, include, utilize, and/or otherwise be associated with a set of electronic components, devices, systems, and/or other appropriate elements. Snake lure 100 may include one or more processors that are able to execute instructions and/or otherwise manipulate data. Snake lure 100 may be able to communicate via networks 430. Snake lure 100 may be at least partially implemented using a device such as device 700 described below. Snake lure 100 may be able to direct, and/or otherwise utilize, components of other devices or systems. For instance, Snake lure 100 may provide various graphical user interfaces (GUIs) via a display of user device 410. Snake lure 100 may utilize data structures such as animal profiles and/or associated management procedures.

Each user device 410 may be a device such as a smart phone, tablet, personal computer (PC), laptop, wearable device (e.g., a smart watch), and/or other type of device that allows user interaction with environment 400. User device 410 may be able to communicate via network 430. User device 410 may typically include various UI elements (e.g., a display, keypad, buttons, touchscreen, etc.) that may be used to provide information and/or instructions to a user and/or receive information, commands, and/or instructions from a user. In some cases, user devices 410 (and/or features described in association therewith) may be implemented via other components of environment 400. For instance, snake lure 100 may have various available UI features (e.g., displays, keypads, buttons, controllers, LEDs, lights or other indicators, etc.) that may be utilized in a similar manner to a user device 410. User device 410 may be implemented using a device similar to device 700 described below.

Server 420 may be, include, utilize, and/or otherwise be associated with a set of electronic components, devices, systems, and/or other appropriate elements. Server 420 may be able to communicate across network 430. Server 420 may be able to execute instructions and/or otherwise process data. Server 420 may collect information from multiple snake lures 100 (e.g., lure status information, captured image data, etc.) and provide information to snake lures 100 (e.g., firmware updates, procedures, profile information, etc.).

Network(s) 430 may include various communication pathways, such as cellular networks, satellite-based systems, radio communication channels, optical communication channels, peer-to-peer communication channels, and/or any other available communication pathways. Information such as animal profiles, management procedures, machine learning models, and/or other relevant information may be communicated across network(s) 430.

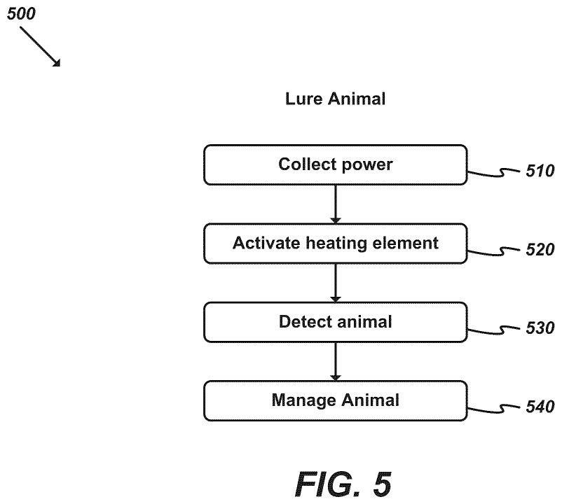

FIG. 5 illustrates an example process 500 for luring or attracting an animal. The process may be performed when a snake lure 100 is powered on or otherwise enabled. In some embodiments, process 500 may be performed by snake lure 100.

As shown, process 500 may include collecting (at 510) power. Power may be collected from various appropriate sources. In the example snake lure 100, power may be collected via solar panel 160 and power management module 150. In such cases, power may be collected during daytime. In some embodiments, power may be provided by a battery or hardwired connection to a power source. In such cases, “collecting” power may involve receiving the power (e.g., that stored at a battery or provided via a power source).

Process 500 may include activating (at 520) a heating element, such as heat source 140. Such a heat source may be activated by a resource such as power management module 150 (e.g., by delivering power to the heat source 140, by sending an activation message to the heat source 140, etc.). In some cases, the heating element may be activated based on various relevant criteria. For instance, the heating element may be activated at night, where images captured by camera sensors 180 or data from a light sensor 180 may be analyzed to determine whether the environment is dark. As another example, the heating element may be activated based on data received from a timer and/or clock associated with a preset operating schedule.

As described above, in some cases an attractant other than heat may be utilized in some embodiments. Thus, rather than activating a heating element, a speaker, bait release, and/or other element may be utilized to deploy the attractant (e.g., a sound, smell, bait, vibration, etc.).

The process may include detecting (at 530) an animal (e.g., a snake) within the enclosure 120. Such a determination may be made in various appropriate ways. For example, image data captured by a camera sensor 180 may be analyzed to determine whether a target animal 110 is present. As another example, data from another type of sensor 180 such as a scale may be analyzed to determine a weight of a target animal 110 within the enclosure 120.

As shown, process 500 may include managing (at 540) a captured animal. Various management procedures may be implemented depending on various relevant factors (e.g., type of animal, size of animal, availability of personnel or other resources, etc.). Animal management will be described in more detail in reference to process 600 below.

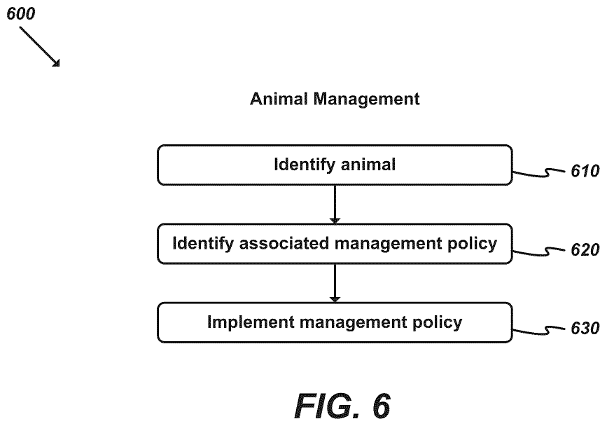

FIG. 6 illustrates an example process 600 for managing an animal. The process may direct and/or inform responses performed by the snake lure 100 and/or other resources (e.g., animal control personnel) based on specified procedures or algorithms. The process 600 may be performed when an animal is detected by the snake lure 100. In some embodiments, process 600 may be performed by snake lure 100.

As shown, process 600 may include identifying (at 610) the animal. Identification may be based on various relevant factors and/or analyses. Identification may utilize data collected by sensors such as camera sensor 180. For example, image data may be captured and compared to various profile images to identify matching profiles (e.g., based on some metric or matching score between capture images and reference images associated with a profile). As another example, animal weight may be measured by a sensor such as a scale and the collected information may be compared to various profiles to identify matches. As still another example, temperature data may be collected via a sensor such as a touchless thermometer and the data may be compared to various profiles to identify matches.

In some embodiments, data captured by sensors 180 may be sent to another resource for analysis and identification. For example, captured image data may be sent to animal control personnel (or some other evaluation entity such as a machine learning model) and a response may be received that includes (or includes a reference to) an animal identification profile and/or some other identifying information.

Animal identification profiles may include information such as a unique identifier, reference data (e.g., reference images or audio files), listings of associated profiles (e.g., an animal management profile associated with the animal, an animal management resource profile associated with a resource appropriate for collecting the animal, an animal management profile associated with the snake lure 100, etc.). The animal identification profiles may include matching criteria (e.g., minimum threshold for image matching) associated with the reference data. Animal identification profiles may be generated and/or selected using machine learning models and/or other artificial intelligence (AI) resources.

Process 600 may include identifying (at 620) management policies associated with the identified animal. If no animal is able to be identified, a default policy may be used. The management policy may be identified based on the matching animal profile information. For example, an animal profile may include references to one or more associated management policies. Management policies may include listings of actions, where actions may be associated with the snake lure 100 and/or personnel. For example, a listing of actions may include an action of sending an alert message, an action of retaining an animal, an action of releasing (or not retaining) an animal (e.g., if a non-target animal has entered the snake lure 100), an action of communicating information to another resource, and/or other relevant and appropriate actions. The management policies may include references to associated resources (e.g., references to profiles associated with animal control agencies, users associated with the snake lure 100, etc.).

Animal management policies may be identified based at least partly on attributes of the snake lure 100. For example, a particular snake lure 100 may not include a door or other retention feature and, thus, a policy that indicates a retention action may not be appropriate. Each snake lure 100 may be associated with a profile indicating capabilities of the snake lure 100 (e.g., available types of sensors 180, retention capabilities, supported communication channels, etc.), status of the snake lure 100 (e.g., charge level, whether an animal is currently housed, etc.), and/or other relevant information. In some cases, the snake lure 100 may send regular update messages to a resource such as user device 410 or server 420 that indicate status of the snake lure 100 and/or provide data captured by sensors 180 (e.g., captured image data).

In some embodiments, data captured by sensors 180 may be sent to another resource for analysis and identification of an animal management policy. For example, captured image data may be sent to animal control personnel (or some other evaluation entity such as a machine learning model) and a response may be received that includes (or includes a reference to) an animal management policy and/or some other identifying information.

The process 600 may include implementing (at 630) the identified management policies. Depending on the listing of actions (and/or other relevant policy attributes), the process 600 may implement various operations or actions. For example, the process 600 may send an alert or similar message via communication module 170 to a resource such as a user device 410 or server 420 associated with an animal control agency or other user. As another example, process 500 may include retaining the animal (e.g., by closing or latching a door or gate). In some cases, a target animal 110 may be automatically retained in the enclosure 120 based on the associated management policy. For example, an actuator or similar device may be used to automatically close and latch entry port 130 such that the target animal 110 has no way to exit the enclosure 120. In some embodiments, the entry port 130 may be latched or closed (or unlatched or opened) remotely (e.g., via an interface of a user device 410). In some cases, when a target animal 110 is detected, an indicator or other UI feature of the snake lure 100 (not shown) such as a flashing light may be activated such that users are aware that an animal 110 has been captured.

In some embodiments, implementation may be based at least partly on instructions or commands received from other entities. For instance, data captured by sensors 180 may be sent to another resource for analysis and identification of an operation or action. For example, captured image data may be sent to animal control personnel (or some other evaluation entity such as a machine learning model) and a response may be received that includes (or includes a reference to) an operation or action (e.g., indicating that a gate or door of the snake lure 100 should be closed, indicating that an attractant be disabled, etc.).

One of ordinary skill in the art will recognize that process 500 and/or process 600 may be implemented in various different ways without departing from the scope of the disclosure. For instance, the elements may be implemented in a different order than shown. As another example, some embodiments may include additional elements or omit various listed elements. Elements or sets of elements may be performed iteratively and/or based on satisfaction of some performance criteria. Non-dependent elements may be performed in parallel. Elements or sets of elements may be performed continuously and/or at regular intervals.

The processes and modules described above may be at least partially implemented as software processes that may be specified as one or more sets of instructions recorded on a non-transitory storage medium. These instructions may be executed by one or more computational element(s) (e.g., microprocessors, microcontrollers, digital signal processors (DSPs), application-specific integrated circuits (ASICs), field programmable gate arrays (FPGAs), other processors, etc.) that may be included in various appropriate devices in order to perform actions specified by the instructions.

As used herein, the terms “computer-readable medium” and “non-transitory storage medium” are entirely restricted to tangible, physical objects that store information in a form that is readable by electronic devices.

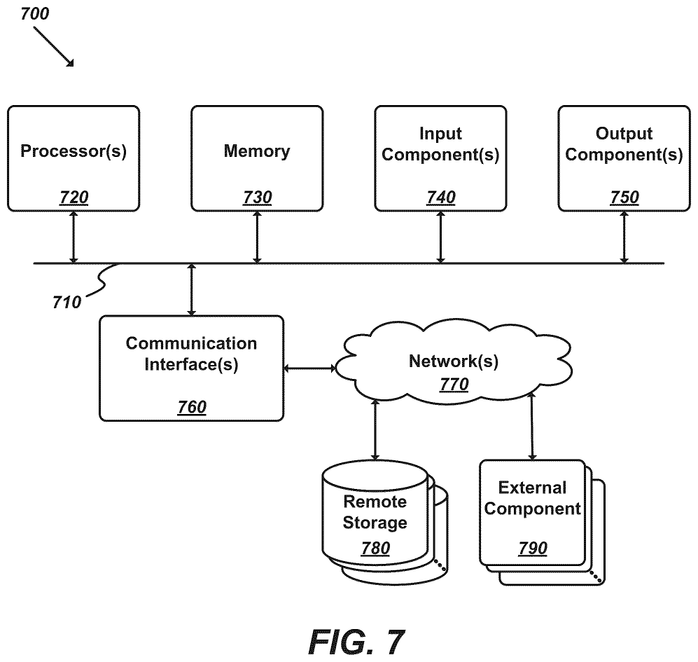

FIG. 7 illustrates a schematic block diagram of an exemplary device (or system or devices) 700 used to implement some embodiments. For example, the systems, devices, components, and/or operations described above in reference to FIG. 1, FIG. 2, FIG. 3, and FIG. 4 may be at least partially implemented using device 700. As another example, the processes described in reference to FIG. 5 and FIG. 6 may be at least partially implemented using device 700.

Device 700 may be implemented using various appropriate elements and/or sub-devices. For instance, device 700 may be implemented using one or more personal computers (PCs), servers, mobile devices (e.g., smartphones), tablet devices, wearable devices, and/or any other appropriate devices. The various devices may work alone (e.g., device 700 may be implemented as a single smartphone) or in conjunction (e.g., some components of the device 700 may be provided by a mobile device while other components are provided by a server).

As shown, device 700 may include at least one communication bus 710, one or more processors 720, memory 730, input components 740, output components 750, and one or more communication interfaces 760.

Bus 710 may include various communication pathways that allow communication among the components of device 700. Processor 720 may include a processor, microprocessor, microcontroller, DSP, logic circuitry, and/or other appropriate processing components that may be able to interpret and execute instructions and/or otherwise manipulate data. Memory 730 may include dynamic and/or non-volatile memory structures and/or devices that may store data and/or instructions for use by other components of device 700. Such a memory device 730 may include space within a single physical memory device or spread across multiple physical memory devices.

Input components 740 may include elements that allow a user to communicate information to the computer system and/or manipulate various operations of the system. The input components may include keyboards, cursor control devices, audio input devices and/or video input devices, touchscreens, motion sensors, etc. Output components 750 may include displays, touchscreens, audio elements such as speakers, indicators such as light-emitting diodes (LEDs), printers, haptic or other sensory elements, etc. Some or all of the input and/or output components may be wirelessly or optically connected to the device 700.

Device 700 may include one or more communication interfaces 760 that are able to connect to one or more networks 770 or other communication pathways. For example, device 700 may be coupled to a web server on the Internet such that a web browser executing on device 700 may interact with the web server as a user interacts with an interface that operates in the web browser. Device 700 may be able to access one or more remote storages 780 and one or more external components 790 through the communication interface 760 and network 770. The communication interface(s) 760 may include one or more application programming interfaces (APIs) that may allow the device 700 to access remote systems and/or storages and also may allow remote systems and/or storages to access device 700 (or elements thereof).

It should be recognized by one of ordinary skill in the art that any or all of the components of computer system 700 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

Device 700 may perform various operations in response to processor 720 executing software instructions stored in a computer-readable medium, such as memory 730. Such operations may include manipulations of the output components 750 (e.g., display of information, haptic feedback, audio outputs, etc.), communication interface 760 (e.g., establishing a communication channel with another device or component, sending and/or receiving sets of messages, etc.), and/or other components of device 700.

The software instructions may be read into memory 730 from another computer-readable medium or from another device. The software instructions stored in memory 730 may cause processor 720 to perform processes described herein. Alternatively, hardwired circuitry and/or dedicated components (e.g., logic circuitry, ASICs, FPGAs, etc.) may be used in place of or in combination with software instructions to implement processes described herein. Thus, implementations described herein are not limited to any specific combination of hardware circuitry and software.

The actual software code or specialized control hardware used to implement an embodiment is not limiting of the embodiment. Thus, the operation and behavior of the embodiment has been described without reference to the specific software code, it being understood that software and control hardware may be implemented based on the description herein.

While certain connections or devices are shown, in practice additional, fewer, or different connections or devices may be used. Furthermore, while various devices and networks are shown separately, in practice the functionality of multiple devices may be provided by a single device or the functionality of one device may be provided by multiple devices. In addition, multiple instantiations of the illustrated networks may be included in a single network, or a particular network may include multiple networks. While some devices are shown as communicating with a network, some such devices may be incorporated, in whole or in part, as a part of the network.

Some implementations are described herein in conjunction with thresholds. To the extent that the term “greater than” (or similar terms) is used herein to describe a relationship of a value to a threshold, it is to be understood that the term “greater than or equal to” (or similar terms) could be similarly contemplated, even if not explicitly stated. Similarly, to the extent that the term “less than” (or similar terms) is used herein to describe a relationship of a value to a threshold, it is to be understood that the term “less than or equal to” (or similar terms) could be similarly contemplated, even if not explicitly stated. Further, the term “satisfying,” when used in relation to a threshold, may refer to “being greater than a threshold,” “being greater than or equal to a threshold,” “being less than a threshold,” “being less than or equal to a threshold,” or other similar terms, depending on the appropriate context.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

The foregoing relates to illustrative details of exemplary embodiments and modifications may be made without departing from the scope of the disclosure. Even though particular combinations of features are recited in the claims and/or disclosed in the specification, these combinations are not intended to limit the possible implementations of the disclosure. In fact, many of these features may be combined in ways not specifically recited in the claims and/or disclosed in the specification. For instance, although each dependent claim listed below may directly depend on only one other claim, the disclosure of the possible implementations includes each dependent claim in combination with every other claim in the claim set.

1. A snake lure comprising:
an enclosure having an entry port;
a power source coupled to the enclosure; and
a heat source coupled to the enclosure.

2. The snake lure of claim 1, wherein the power source comprises a solar panel.

3. The snake lure of claim 1, wherein the heat source comprises a silicone heating pad.

4. The snake lure of claim 1 further comprising a camera coupled to an interior surface of the enclosure.

5. The snake lure of claim 1 further comprising a wireless communication module.

6. The snake lure of claim 1, wherein the entry port comprises an automated latching feature.

7. The snake lure of claim 1 further comprising a set of user interface (UI) features coupled to an exterior surface of the enclosure.

8. A snake lure, comprising:
one or more processors configured to:
collect power;
activate a heating element;
detect an animal; and
implement an animal management policy.

9. The snake lure of claim 8, wherein detecting the animal comprises capturing image data and analyzing the captured image data.

10. The snake lure of claim 8, wherein implementing the animal management policy comprises:
identifying the animal; and
identifying the animal management policy associated with the animal.

11. The snake lure of claim 10, wherein identifying the animal comprises capturing image data and comparing the image data to a set of profiles to identify a matching profile.

12. The snake lure of claim 8, wherein implementing the animal management policy comprises identifying a listing of actions associated with the animal management policy and implementing at least one action from the listing of actions.

13. The snake lure of claim 12, wherein the at least one action comprises sending an alert message.

14. The snake lure of claim 12, wherein the at least one action comprises retaining the animal.

15. A method comprising:
collecting power;
activating a heating element;
detecting an animal; and
implementing an animal management policy.

16. The method of claim 15, wherein detecting the animal comprises capturing image data and analyzing the captured image data.

17. The method of claim 15, wherein implementing the animal management policy comprises:
identifying the animal; and
identifying the animal management policy associated with the animal.

18. The method of claim 17, wherein identifying the animal comprises capturing image data and comparing the image data to a set of profiles to identify a matching profile.

19. The method of claim 15, wherein implementing the animal management policy comprises identifying a listing of actions associated with the animal management policy and implementing at least one action from the listing of actions.

20. The method of claim 18, wherein the at least one action comprises sending an alert message or retaining the animal.
